(19) United States
(12) Patent Application Publication
(10) Pub. No.: US 2014/0341962 A1
(43) Pub. Date: Nov. 20, 2014

(54) ENCAPSULATED ACTIVES

(71) Applicant: Rohm and Haas Company, Philadelphia, PA (US)

(72) Inventors: John W. Ashmore, Lansdale, PA (US); Boris Polanuyer, Lansdale, PA (US); David Laganella, Swedesboro, NJ (US)

(21) Appl. No.: 14/369,088

(22) PCT Filed: Dec. 27, 2012
(86) PCT No.: PCT/US2012/071744

§ 371 Date: Jun. 26, 2014

Related U.S. Application Data
(60) Provisional application No. 61/581,235, filed on Dec. 29, 2011.

(51) Int. Cl. C09D 5/16; B05D 3/00; C08K 3/30

(52) U.S. Cl. CPC C09D 5/1687; C09D 5/1637; C08K 3/30; B05D 3/007; C08K 2003/3045
USPC 424/419; 424/78.09; 427/385.5

(57) ABSTRACT

A composition is provided with increased release comprising an encapsulated active and one or more metal additive. Also provided is a coating composition comprising an encapsulated active, and one or more metal additive, and one or more binder polymer, one or more binder precursor, or a mixture thereof, and one or more pigment. Also provided is a method of making such compositions. Also provided is a method of providing a surface that resists marine fouling wherein said method comprises applying a layer of such compositions to a substrate and drying said layer or allowing said layer to dry.

Encapsulated actives offer some advantages. The advantages include controlled release of the active from the encapsulant, protection of the active from external conditions and targeted delivery. The release of the active has been shown to be dependent on the conditions of capsule preparation. U.S. Pat. No. 4,444,699 describes a process to prepare microcapsules with a greater shelf life wherein the capsule walls are more impermeable to active release when metal-containing salts are added during the preparation. E. Bonatz, “Amino resin microcapsules”, Acta Polymerica, volume 40, pages 683-690, 1989 demonstrates that addition of metal-containing salts to capsules results in a decrease in the release of the encapsulated active.

Often it is desirable to prepare a composition of encapsulated active with increased release.

The following is a statement of the invention.

A first aspect of the present invention is a composition with increased release comprising A) an encapsulated active and B) one or more metal additive.

A second aspect of the present invention is a coating composition comprising A) an encapsulated active and B) one or more metal additive and C) one or more binder polymer, one or more binder precursor, or a mixture thereof; and D) one or more pigment.

A third aspect of the present invention is a method of making the composition in the second aspect.

Also contemplated is a method of providing a surface that resists marine fouling wherein said method comprises applying a layer of the composition in the second aspect to a substrate and drying said layer or allowing said layer to dry.

Preferred methods of making the composition in the present invention apply to either the first or the second aspect or both the first and second aspect. Preferred methods of making the surface that resists marine fouling apply to either the first or second aspect or both the first and second aspect.

The following is a detailed description of the invention.

As used herein, the following terms have the designated definitions, unless the context clearly indicates otherwise.

A coating composition is a composition that is capable of being applied as a layer on the surface of a substrate and capable of forming a dry layer (the “dry coating”) that adheres to the surface of the substrate.

The coating composition of the present invention is a solvent borne coating composition. The preferred amount of water in the continuous liquid medium of the solvent borne coating is, by weight based on the weight of the continuous liquid medium, 10% or less; more preferably 5% or less; more preferably 2% or less; more preferably 1% or less.

A marine coating composition is a coating composition that is capable of forming a dry coating on the surface of a marine object. The marine coating composition is capable of being applied as a layer on the surface of a marine object and capable of forming a dry layer that adheres to the surface of the object. After formation of the dry coating, the dry coating will adhere to the surface for a usefully long time, even when some or all of the coated surface remains under water for significant amounts of time (i.e., at least one hour per day). Marine objects are those that are put to use in environments in which some or all of the objects are under water for significant amounts of time. Examples of marine objects include ships, piers, docks, pilings, fishnets, heat exchangers, dams, aquaculture cages and nets, and piping structures, such as intake screens.

A marine coating composition that is effective at inhibiting the growth of one or more marine fouling organism is a marine anti-fouling (MAF) coating composition. Marine fouling organisms tend to grow on surfaces that are submerged under water and include hard and soft fouling organisms, including algae, tunicates, hydroids, bivalves bryozoans, polychaete, worms, sponges, and barnacles. A marine anti-foulant is a compound that is added to a marine coating composition and that improves the ability of the marine coating composition to inhibit the growth of one or more marine fouling organism. A marine anti-fouling paint describes a composition containing binders, pigments, one or more biocide compounds, and optionally one or more adjuvant.

A polymer (synonymously called a polymeric compound) is a relatively large molecule made up of the reaction products of smaller chemical repeat units. A polymer has number-average molecular weight of 1,000 or higher. Polymers may be homopolymers in which the repeat units are all identical or copolymers in which two or more different repeat units are present. The polymers may be chemically cross-linked with covalent bonds. A three dimensional network is formed when the chemically cross-linked polymers are fully cross-linked. A fully cross-linked polymer is insoluble in water and solvents.

The term prepolymer refers to a monomer or system of monomers that have undergone addition reactions. An addition reaction is a reaction in which two or more monomers combine to form a larger molecule. Preferably, the polycondensation reaction of the prepolymers is avoided by controlling the reaction conditions of the addition reaction. A polycondensation reaction is a reaction in which two functional groups combine together to form a larger molecule with the loss of a small molecule. The reaction conditions of the addition reactions include variables such as monomer concentration, reaction time, reaction temperature, and reaction pH. Preferably, the prepolymers are water-soluble. A prepolymer is water-soluble if it forms a homogeneous aqueous solution. Preferred prepolymers have solubility in water at 25° C., by weight based on the weight of the water in the aqueous solution, of 70% or less; more preferably 60% or less; more preferably 50% or less.

The prepolymers may be cured by polycondensation reactions of reactive groups to form a cured polymer. The reactive groups may be a part of the chemical composition of the prepolymers and separate compounds containing reactive groups may be added. The polycondensation reactions increase the cross-links between the constituent prepolymers until a polymeric three-dimensional network is created. Generally, the cured polymer is insoluble in water and solvents.

Coacervation reagents are reagents which, individually or in combination, assist in the spontaneous formation of spherical droplets containing assorted organic molecules. The spherical droplets are coated with the coacervate reagents and have diameters in the range of 0.1 micrometer to 100 micrometer. Most preferred 2 micrometer to 20 micrometer.

An amine resin contains a polymeric material which is a reaction product of one or more amine-containing compound and one or more amine-reactive compound and optionally a phenol reagent. An amine-containing compound contains a nitrogen atom with a lone pair of electrons. Preferred amine-containing compounds contain one or more selected from urea, thiourea, melamine, benzoguanamine, or mixtures thereof. An amine-reactive compound is any reagent with sufficient acidity or electrophilicity to react with the nitrogen atom of an amine-containing compound in the pH range of 2.0 to 8.0 and temperatures between 0° C. to 100° C. Preferred amine-reactive compounds contain one or more selected from formaldehyde, acetaldehyde, glutaraldehyde, or mixtures thereof. A phenol reagent is a compound which contains one or more hydroxyl groups bonded to a carbon atom that is part of an aromatic ring; a phenol reagent may or may not have further substituents attached to the aromatic ring. A preferred phenol reagent is resorcinol.

An amine resin prepolymer is a prepolymer containing one or more amine-containing compound, one or more amine-reactive compound and optionally a phenol reagent. The amine resin prepolymer may include methylol functional groups. Preferably, the pH of the mixture to prepare the amine resin prepolymer is 7.0 or greater and the temperature is 20° C. or greater. Preferably, the pH of the mixture to prepare the amine resin prepolymer is less than 10.0 and the temperature is less than 100° C. A melamine-formaldehyde (MF) prepolymer is an amine resin prepolymer in which the one or more amine-containing compound includes melamine and the one or more amine-reactive compound includes formaldehyde. A urea-formaldehyde (UF) prepolymer is an amine resin prepolymer in which the one or more amine-containing compound includes urea and the one or more amine-reactive compound includes formaldehyde

An amine resin cross-linker is an amine resin prepolymer which contains alkoxy functional groups. An alkoxy functional group is an alkyl group singularly bonded to oxygen. Amine resin cross-linkers may be prepared by alkyl substitution of the methylol functional groups of the amine resin prepolymer. Amine resin cross-linkers may be used as cross-linking reagents for cure reactions. The cure reactions of amine resin cross-linkers may require the addition of an acid catalyst. The alkoxy functional groups of the amine resin cross-linker include alkyl groups such as methyl, ethyl, n-butyl, iso-butyl, and the like. The alkyl groups of the alkoxy functional groups may have a significant impact on the final properties of the amine resin cross-linker A methylated amine resin cross-linker is an amine resin cross-linker which contains methoxymethyl functional groups. A “highly methylated” methylated amine resin contains primarily methoxymethyl functional groups. A “partially methylated” amine resin contains methoxymethyl and methylol functional groups. A “high imino” methylated amine resin contains methoxymethyl and imino functional groups.

A cross-linking reaction is a chemical reaction which involves a cross-linker. A cross-linker (synonymously called a cross-linking reagent) is a reagent that contains two or more functional groups which may covalently bond two or more molecules. The cross-linking reactions include at least one cross-linker and one or more of the following: a cross-linker and other molecules in the cross-linking reaction mixture with functional groups that are reactive with the cross-linker functional groups. Some examples of functional groups include hydroxyl, carboxyl and amide.

A cure reaction is a chemical process of converting a prepolymer or a polymer into a polymer of higher molar mass and connectivity and finally into a network. Curing is typically accomplished by chemical reactions induced by one or more of heating, photo-irradiation, or mixing with a chemical curing agent.

A water-soluble cationic amino resin is a compound obtained by reaction of an amine resin prepolymer with a cationic modifier agent. A cationic modifier agent is a compound which contains functional groups which are capable of ionization to generate a positive charge. Preferably the functional groups of the cationic modifier agent are amines which may be reacted with the amine resin prepolymer and which may be protonated to yield a positively charged nitrogen group. For example, a urea-formaldehyde amine resin prepolymer may be subjected to polycondensation in a known manner with a cationic modifier agent. Some examples of cationic modifier agents are diethylenetriamine, triethylenetetramine, tetraethylenetriamine, and guanidine. An example of a water-soluble cationic amine resin is available under the trade name of “U-Ramin™ P-1500” resin from Mitsui Kagaku K.K.

A transition metal is any element in the d-block of the periodic table, which includes groups 3 to 12 on the periodic table.

A solvent is anything that is a liquid when the temperature is greater than or equal to 20° C. at 1 atm. Preferred solvents include aliphatic compounds (such as mineral spirits), aromatic compounds, alkyl-substituted aromatic compounds (such as xylene, Solveso solvents, and Aromatic 100 and Aromatic 150 solvents), ketones (such as methyl isobutyl ketone and methyl isoamyl ketone), alcohols (such as n-butanol and propylene glycol methyl ethers), and mixtures thereof.

Seawater is water from a sea or ocean. On average, seawater in the world's oceans has a salinity of about 3.5 wt % and an average density at the ocean surface of 1.025 g/ml. Artificial seawater is a mixture of water with dissolved mineral salts that simulates seawater. An example of artificial seawater is synthetic seawater available from Ricca™ (ASTM D1141).

A surfactant is a molecule that contains a hydrophobic portion and a hydrophilic portion. The hydrophobic portion is typically an alkyl or aryl containing chain and is referred to as the tail group. The hydrophilic portion is often referred to as the head group. Surfactant molecules are classified according to the ionic charge of the hydrophilic head group. These classes include anionic, cationic, nonionic, and zwitterionic. Preferred surfactant molecules are anionic surfactants which contains a negative charge. The charge may be based on permanent anions (e.g. sulfate, sulfonate, phosphate) or pH-dependent anions (e.g. carboxylate).

An active is a compound which helps directly in achieving its performance objectives. Examples of actives are agricultural chemicals including insecticides, fungicides, herbicides, virucides and attractants. Examples of actives for pharmacy, medical and cosmetic applications include drugs, living cells, and fragrances. Actives may also include auxiliary materials for food stuffs and feed. Other actives may include lubricants, inorganic materials, color formers, adhesives, and reagents for self-healing applications. Preferred actives are biocide compounds.

A biocide compound is a chemical substance which is capable of inhibiting growth of, or killing, one or more species of bacteria, fungus, algae, germs, viruses, and parasites by chemical or biological means. Biocide compounds are used in application areas such as marine, building and construction, medicine, agriculture, and forestry.

Preferred biocide compounds are isothiazolones; more preferred are 4,5-dichloro-2-n-octyl-3(2H)-isothiazolone (DCOIT), 2-n-octyl-3(2H)-isothiazolone (OIT), benzisothiazolone (BIT), alkyl derivatives thereof, and mixtures thereof; more preferred are DCOIT, OIT, BIT, and mixtures thereof; more preferred is DCOIT. Preferred biocide compounds have solubility in water at 25° C., by weight based on the weight of the water, of 2% or less; more preferably 1% or less.

The active may be used individually, or two or more actives may be used together if they are chemically stable when mixed together. The actives may be solid or liquid. A liquid active is one in which the melting point is less than or equal to 20° C. at 1 atm. A solid active is one in which the melting point is greater than 20° C. at 1 atm. In the case where the active is solid, it can be encapsulated as it is, or after being melted by heating to a temperature above its melting point.

The actives may be mixed with a partially water miscible solvent, in order to enhance natural water or saltwater release. A partially water miscible solvent is a solvent that has solubility in water at 20° C. of 0.01% to 5% by weight based on the weight of the water. If such a solvent is present, preferred are solvents having boiling point at 1 atm of 100° C. or higher.

An encapsulated active is an active which is contained within a surrounding matrix. The active within the matrix is referred to as the core, internal phase, or fill. The surrounding matrix is referred to as the shell, coating, wall, or membrane.

A “dispersion” is a collection of discrete particles distributed throughout a continuous medium. The particles may be solid or liquid or a mixture thereof. A dispersion is said to be an aqueous dispersion if the continuous medium is an aqueous medium. A continuous medium is “aqueous” if the composition of the continuous medium is 50% or more water, by weight based on the weight of the continuous medium. An aqueous dispersion of the encapsulated active preferably contains an amount of solids, based on the total weight of the aqueous composition, of 10% to 30%.

A dispersion is said to be a solvent dispersion if the continuous medium is “non-aqueous”. A continuous medium is “non-aqueous” if the composition of the continuous medium is less than 50% water by weight based on the weight of the continuous medium. A solvent dispersion of the encapsulated active is any dispersion in a solvent containing an amount of solids, based on the total weight of the solvent dispersion, of 0.1% to 30%.

A dried composition is any composition with a total solids content of, based on the total weight of the dried composition, more than 94%. A dried encapsulated active may be prepared by drying the aqueous dispersion of the encapsulated active. Preferably, the moisture content of the dried encapsulated active is, based on the total weight of the dried encapsulated active, less than 5%. A wetcake of the encapsulated active may be obtained through filtration of the aqueous dispersion of the encapsulated active. The amount of solids in the wetcake, based on the total weight of the wetcake, may be 30% to 65%. An aqueous dispersion of the encapsulated active may be prepared by addition of water to the wetcake.

As used herein, when a ratio of two quantities is said to be “X:100 or more,” it is meant that the ratio is Y:100, where Y is equal to or greater than X. Similarly, when a ratio of two quantities is said to be “Z:100 or less,” it is meant that the ratio is W:100, where W is equal to or less than Z.

Encapsulated actives may be prepared by various chemical and physical methods and with different encapsulant materials. Methods used to prepare encapsulated actives include phase separation (e.g. gelatin/gum arabic) and interfacial polymerization (e.g. dicarboxylic acid dichlorides and di- or triamines). A preferred encapsulated active is of the core/shell type, where the core contains the active as describe herein, which is surrounded by a covering of encapsulant materials. Encapsulant materials are a combination of one or more reagents and compounds which are used to form a protective shell around the active core.

A preferred method to prepare the encapsulated actives includes combining encapsulant materials with an emulsified active. An emulsified active is a colloidal dispersion of an active in an immiscible continuous phase. The encapsulated active may contain multiple layers of the encapsulant materials, for example an inner encapsulant and an outer encapsulant. Encapsulated actives composed of different inner encapsulant and outer encapsulant may be prepared depending on the reagents used. See U.S. Pat. No. 6,486,099 or U.S. Pat. No. 7,550,200 for details of a process to prepare encapsulated actives.

The following is a general outline of the processes to prepare the present invention.

Emulsified Active:

Preferably, an aqueous dispersion of the active may be first prepared by emulsification of a mixture of water, active, and one or more emulsion reagents to form an emulsified active. An emulsified active containing an inner shell may be prepared by including inner shell encapsulant materials during the preparation of the emulsified active.

Cure Mixture:

Preferably, a cure mixture may be prepared by addition of the materials for the outer encapsulant to the aqueous dispersion of the emulsified active. The cure mixture is allowed to undergo cure reactions. It is envisioned that the materials for the outer shell are deposited onto the emulsified active during a cure reaction of the cure mixture to prepare an aqueous dispersion of the encapsulated active. Optionally, an emulsion cure mixture may be prepared by addition of the materials for the outer encapsulant to the mixture of water, active and one or more emulsion reagents before the formation of the emulsified active. The emulsion cure mixture is subsequently emulsified to form a cure mixture.

Introduction of Metal Additive to the Encapsulated Active:

A metal-containing aqueous dispersion of the encapsulated active is a mixture containing the aqueous dispersion of the encapsulated active and a metal additive. The metal-containing aqueous dispersion of the encapsulated active may be dried to prepare a metal-containing dried encapsulated active. A metal-containing solid mixture may be prepared by mixing the metal additive with the dried encapsulated active.

Coating Preparation:

A metal-containing coating composition of the encapsulated active may be prepared by addition of one or more of the metal-containing dried encapsulated active and the metal-containing solid mixture to the coating composition.

In the following description, some processes are labeled as “first step”, “second step”, etc. It is contemplated that these steps will be performed in the order specified by the labels “first”, “second”, etc. It is further contemplated that other steps may be performed before, during or after the labeled steps, unless the descriptions state otherwise.

A preferred first step in making the composition of the present invention is to make an emulsified active. The composition of the mixture to prepare the emulsified active contains water, active, and optionally one or more emulsion reagents. An emulsion reagent is a reagent or compound which stabilizes an emulsion by increasing its kinetic stability. If more than one emulsion reagent is used, it may be added to the emulsified active mixture sequentially or simultaneously. Preferably, a liquid form of the active is added to an aqueous solution of the emulsion reagents.

In one aspect of the present invention, the preferred emulsion reagents are compatibilizers. A compatibilizer is a chemical additive that modifies the interfacial properties of a blend of immiscible materials and stabilizes the blend. Typically, the compatibilizer contains segments of similar structure or solubility parameters as the materials being mixed. Common compatibilizers are copolymers of olefins or styrene and functionalized monomers including esters (for example, methyl methacrylate), carboxylic acids (for example, ethylene acrylic acid) and acid anhydrides of carboxylic acids such as maleic anhydride. Preferred compatibilizers are partially hydrolyzed copolymers of olefins and acid anhydrides. Preferred compatibilizers are partially hydrolyzed poly(ethylene-co-maleic anhydride) (EMA). Preferably, the amount of compatibilizer is, by weight based on the weight of the total mixture to prepare the emulsified active, 0.1% or more; preferably 0.5% or more. Preferably, the amount of compatibilizer is, by weight based on the weight of the total mixture to prepare the emulsified active, 2% or less; more preferably 1% or less.

Other emulsion reagents may be used in combination with the compatibilizers to generate an emulsified active with an inner encapsulant. In one embodiment of the present invention, an inner encapsulant E1 is prepared. In another embodiment of the present invention, an inner encapsulant E2 is prepared. Preferably, E1 contains an amine resin cross-linker Preferred amine resin cross-linkers are methylated amine resins. Among the methylated amine resin cross-linkers, preferred are those that are water soluble. Among the methylated amine resin cross-linkers, preferred are those that are reactive at a pH of 3.0 or more and a temperature of 25° C. or more. Among the methylated amine resin cross-linkers, preferred are those that are reactive at a pH of 6.5 or less and a temperature of 100° C. or less. Useful methylated amine resin cross-linkers are, for example, Cymel™ 385 cross-linking agent available from Cytec. Preferably, the ratio of the weight of amine resin cross-linker to the weight of the encapsulant materials is 8:100 or higher; more preferably 15:100 or higher. Preferably, the ratio of the weight of amine resin cross-linker to the weight of the encapsulant materials is 30:100 or lower; more preferably 20:100 or lower.

A buffer may be added to the emulsified active with E1. Preferably, the buffer is included after the formation of the emulsified active with E1. Preferably, the pH range of the buffer is 5 to 10. Preferably, the buffer is mixed with the emulsified active with E1 at a temperature of 40° C. or more for 10 minutes or more. Preferably, the buffer is mixed with the emulsified active with E1 at a temperature of 100° C. or less for 2 hours or less.

Optionally, one or more dopants may be added to the emulsified active with E1. A dopant is a substance that is capable of altering the properties of the encapsulated active. Preferably, the dopant is added after the formation of the emulsified active with E1. The dopant may be added before or after the buffer. When a dopant is used, preferred dopants are partially or fully hydrolyzed polyvinyl alcohol (PVOH), hydroxyethyl cellulose, hydroxypropyl cellulose, methyl cellulose, hydroxyethylmethylcellulose, hydroxypropylmethylcellulose, hydroxybutylmethylcellulose, ethylhydroxyethylcellulose, polyethylene glycols, and mixtures thereof. When a dopant is used, more preferred is partially or fully hydrolyzed PVOH. Preferably, the ratio of the weight of dopant to the weight of the encapsulant materials is 1:100 or higher; more preferably 3:100 or higher. Preferably, the ratio of the weight of dopant to the weight of the encapsulant materials is 8:100 or lower; more preferably 6:100 or lower.

In another aspect of the present invention, the preferred emulsion reagents contain a mixture of buffers, surfactants and coacervation reagents. The mixture of buffers, surfactants and coacervation reagents form an emulsified active containing an inner encapsulant, E2. Examples of surfactants for E2 include aliphatic acid salts, higher alcohol sulfate ester salts, alkylbenzene sulfonic acid salts, and alkyl-naphthalene sulfonic acid salts, while sodium dodecylbenzene sulfonate is most preferred (NEOPELEX, made by Kao K.K., is an example of a commercial product). Preferably, the amount of surfactant is, by weight based on the weight of the total mixture to prepare the emulsified active, 0.01% or more; preferably 0.03% or more. Preferably, the amount of surfactant is, by weight based on the weight of the total mixture to prepare the emulsified active, 1% or less; more preferably 0.5% or less; more preferably 0.1% or less.

Preferred coacervation reagents include water-soluble cationic amino resins. Useful water-soluble cationic amino resins are URamin™ P1500 resin available from Mitsui Kagaku K.K. Preferably, the ratio of the weight of coacervation reagents to the weight of the encapsulant materials is 10:100 or higher; more preferably 15:100 or higher. Preferably, the ratio of the weight of dopant to the weight of the encapsulant materials is 30:100 or lower; more preferably 22:100 or lower. Preferably the buffer for the emulsified active with E2 is included with the mixture of the surfactant and coacervation reagents before the formation of the emulsified active with E2. Preferably, the pH range of the buffer is 5 to 10.

Preferably, the temperature of the mixture to prepare the emulsified active with E1 and the emulsified active with E2 is no less than 5° C. below the melting temperature of the active. Preferably, the pH of the mixture to prepare the emulsified active with E1 and the emulsified active with E2 is 1 or more. Preferably, the pH of the mixture to prepare the emulsified active with E1 and the emulsified active with E2 is 6 or less; more preferably 5.5 or less.

An emulsion of the mixture of the reagents to prepare the emulsified active with E1 and the emulsified active with E2 may be prepared, for example, using any emulsion method of mixing such as a homogenizer, an emulsifier, or high shear mixers. Preferably, a high shear mixer is used at a speed in the range 5000 rpm to 9000 rpm using an emulsion volume feed rate in the range 120 ml/min to 500 ml/min for a time period of 3 to 25 minutes.

Preferably, the mean volume diameter of the emulsified active with E1 and the emulsified active with E2 is between 0.1 micron and 80 micron; more preferably between 1 micron and 50 micron.

A preferred second step in making the composition of the present invention is to prepare a cure mixture. Preferably, the cure mixture is prepared by adding the materials for the outer encapsulant to the emulsified active. Preferably, the outer encapsulant of the encapsulated active contains an amine resin.

It is contemplated that the cure mixture may be selected from one of the following: C1, C2, or EC. Preferably a cure mixture C1, prepared using the emulsified active with E1, includes one or more amine-containing compound and one or more amine-reactive compound and optionally a phenol reagent. An addition method, A1, includes adding a mixture containing the one or more amine-containing compound and the one or more amine-reactive compound and the phenol reagent, if used, to the mixture of the emulsified active with E1. An addition method, A2, includes adding a mixture containing the one or more amine-containing compound and the phenol reagent, if used, to the mixture of the emulsified active with E1 first, followed by the addition of the amine-reactive compound. One or more A1 and A2 may be used to prepare C1.

In another aspect of the present invention a cure mixture, C2, is prepared using the emulsified active with E2. Preferably, C2 contains one or more amine resin prepolymers. Preferably, C2 includes at least one MF prepolymer and at least one UF prepolymer.

In another aspect of the present invention, a combined first step and second step is contemplated to prepare an emulsion cure mixture (EC). EC contains the reagents used to prepare the emulsified active and the outer encapsulant materials. An emulsion of EC may be prepared using aforementioned emulsion methods followed by a cure reaction. Preferably, the reagents used to prepare E2 and C2 are used to prepare EC.

Preferably the ratio of the weight of amine resin used in C1, C2, and EC to the weight of the encapsulant materials is 45:100 or higher; more preferably 55:100 or higher. Preferably, the ratio of the weight of amine resin used in C1, C2, and EC to the weight of the encapsulant materials is 100:100 or lower; more preferably 80:100 or lower. The polymerization of the outer encapsulant materials in C1, C2, and EC may be initiated by adding one or more acid catalyst to the cure mixture. The polymerized outer encapsulant materials are envisioned to deposit onto the emulsified active. Examples of acid catalysts may include organic acids, inorganic acids, and acidic or readily hydrolyzed salts. Organic acids include, for example, formic acid, acetic acid and citric acid; inorganic acids include, for example, hydrochloric acid, sulfuric acid, nitric acid and phosphoric acid; and acidic or readily hydrolyzed salts include, for example, aluminum sulfate, titanium oxychloride, magnesium chloride, ammonium chloride, ammonium nitrate, ammonium sulfate, and ammonium acetate. Preferred acid catalysts are acetic acid, hydrochloric acid, sulfuric acid, and citric acid.

Preferably, the pH of the cure mixture is in the range of 1 to 9, preferably 1 to 6, more preferably 2 to 5. Preferably, the temperature of the cure mixture is 25° C. or higher; more preferably, 35° C. or higher. Preferably, the temperature of the cure mixture is 95° C. or lower.

Preferably, the cure mixture is mixed for 5 hours or more. Preferably the cure mixture is mixed for 48 hours or less. After the cure mixture has mixed, it may be neutralized for example, by increasing the pH to 7.0 using a strong base. The neutralized cure mixture may be sieved to remove larger particles and washed with water to remove salts generated from the neutralization of the cure mixture. The washed cure mixture may be vacuum-filtered using, for example, a Buchner funnel, resulting in a wetcake.

In some embodiments of the present invention, a dried encapsulated active is prepared. Methods to obtain a dried encapsulated active may include drying the aqueous dispersion of the encapsulated active at different temperatures and pressures. Useful temperatures ranges may be from 25° C. to 100° C. Useful pressure ranges may be from 0.02 atm to 1 atm. Other drying methods may include freeze drying or spray drying the aqueous dispersion of the encapsulated active. A preferred method of obtaining a dried encapsulated active is spray drying the aqueous dispersion of the encapsulated active.

Preferably, the mean volume diameter of the particles in the aqueous dispersion of the encapsulated active is between 0.1 micron and 80 micron; more preferably between 0.1 micron and 50 micron; most preferred 2 micron to 20 micron

The composition of the present invention contains one or more metal additive. A metal additive is any metal-containing compound. Metal-containing compounds include elemental metal, metal alloys, inorganic compounds containing metal ions, metal salts, and organometallic compounds such as coordination complexes and chelated complexes. Preferred metal additives include metals selected from the transition metals or from group 1 or from group 2 of the periodic table of the chemical elements. Preferred transition metals are selected from period 4. When metal salt is used, preferred anions for the metal salts are selected from the group including chloride, sulfate, phosphate, nitrate, citrate, and oxide. Most preferred anions include chloride, sulfate, and oxide. When the metal salt is used, the metal salt preferably contains copper. When organometallic compound is used, a preferred organic ligand of the organometallic compound is pyrithione. Preferred metal additives are copper sulfate and copper pyrithione.

The metal additive may be added to the encapsulated active using at least one of the following methods: MA, MA1, MA2, and MA3. The preferred methods are selected from the following: MA1 and MA2.

A metal-containing aqueous composition may be prepared using method MA, in which the metal additive is mixed with the aqueous composition of the encapsulated active.

A metal-containing dried composition may be prepared using MA1, in which the metal-containing aqueous composition is spray dried

A metal-containing solid mixture may be prepared using MA2, in which a solid metal additive is mixed with the dried encapsulated active.

A metal-containing solvent dispersion may be prepared using MA3, in which the metal additive is mixed with a solvent dispersion of the encapsulated active. The metal additive may be a solid or a solvent dispersion. Preferably, the mean volume diameter of the particles in the solvent dispersion of the encapsulated active is between 0.1 micron and 80 micron; more preferably between 0.1 micron and 50 micron; most preferred between 2 micron and 20 micron.

In some embodiments, the composition of the present invention includes one or more binder and one or more pigment to form a coating composition. A binder is a substance that is capable of forming a film; that is, when the binder is present in a solvent borne composition, when that composition is applied as a layer on a substrate and then dried or allowed to dry at ambient temperature (which may be any temperature from 0° C. to 45° C.) to form a dry coating, the binder is capable of forming a continuous film in that dry coating. A solvent borne composition is a liquid composition that has a continuous liquid medium and the continuous liquid medium contains one or more compound that is not water. During and after the drying process, the binder may or may not undergo chemical reactions that increase molecular weight and/or create cross-links; if such chemical reactions occur, it is contemplated that the chemical reactions will not prevent the binder from forming a film. Preferred binders are soluble in the continuous liquid medium of the composition. Preferred binders contain one or more rosin, one or more polymer, or a mixture thereof. Preferred rosins include unmodified rosin, alkylated rosin esters and rosin acid salts. Preferred polymers include acrylic resin acid salts, silyl acrylates and silicone; more preferred are zinc and copper salts of acrylic resin acids, silylacrylate polymers and silicone polymers. Acrylic resin acids are a group of related thermoplastic or thermosetting plastic substances derived from acrylic acid, methacrylic acid or other related compounds.

When one or more binder is present, the preferred total amount of all binder is, by weight based on the total weight of the composition, 5% or more; more preferably 10% or more. When one or more binder is present, the preferred total amount of all binder is, by weight based on the total weight of the composition, 30% or less; more preferably 25% or less.

Preferably the coating composition of the present invention further contains one or more pigment. A pigment is a particulate solid. A pigment is solid over a temperature range that includes the range −10° C. to 95° C. A pigment is present in the form of particles, which may be spherical, approximately spherical, irregularly rounded, roughly rectangular, sheetlike, lamelliform, needlelike, bristlelike, threadlike, or a combination thereof. A pigment may be organic (for example, polymeric) or inorganic (for example, oxides, carbonates, clays, etc.). When a particle is not spherical, its diameter is considered herein to be the diameter of a sphere that has the same volume as that particle.

When pigment particles are present in the composition of the present invention, the preferred weight-average diameter of the particles is 0.2 micron to 10 micron.

When one or more pigment is present, the preferred total amount of pigment is, by weight based on the total weight of the composition, 20% or more; more preferably 40% or more. When one or more pigment is present, the preferred total amount of pigment is, by weight based on the total weight of the composition, 75% or less; more preferably 65% or less.

The coating composition of the present invention optionally further contains one or more adjuvant. Some adjuvants include, for example, dispersants, coalescents, thickeners, colorants, waxes, additional biocides, and mixtures thereof. Preferred are compositions that contain adjuvants that are suitable for use in marine anti-fouling paints.

In describing the preferred methods of making the coating composition of the present invention, it is useful herein to label as “coating ingredients” the following: every binder, every pigment, and every adjuvant.

A metal-containing coating composition of the encapsulated active may be prepared using one or more of the methods MAC 1, MAC2, and MAC3.

In MAC1, the metal-containing dried composition prepared using MA1 is mixed with the coating ingredients. The preferred amount of metal additive in the metal-containing coating composition prepared using MAC1 is, based on the weight of the dried encapsulated active, 0.1% or more; more preferably 0.25% or more. The preferred amount of metal additive in the metal-containing coating composition prepared using MAC1 is, based on the weight of the dried encapsulated active, 7% or less; more preferably 5% or less.

In MAC2, the metal-containing solid mixture prepared using MA2 is mixed with the coating ingredients. In MAC3, the metal-containing solvent dispersion prepared using MA3 is mixed with the coating ingredients. The preferred amount of metal additive in the metal-containing coating composition prepared using MAC2 or MAC3 is, based on the total weight of the coating composition, 0.25% or more; more preferably 0.5% or more. The preferred amount of metal additive in the metal-containing coating composition prepared using MAC2 or MAC3 is, based on the total weight of the coating composition, 4% or less; more preferably 3% or less.

When the metal-containing coating composition is prepared using an encapsulated active containing E1, it is preferred to use the copper sulfate metal additive. Preferably, MAC2 is used to prepare the metal-containing coating composition containing the encapsulated active containing E1 and copper sulfate metal additive. When the metal-containing coating composition is prepared using an encapsulated active containing E2, it is preferred to use at least one of the following metal additives: copper sulfate and copper pyrithione. When the metal-containing coating composition containing the encapsulated active containing E2 and at least one of the following metal additives: copper sulfate and copper pyrithione is prepared, it is preferred to use MAC1 or MAC2. Preferably, the amount of the encapsulated active is, based on the total weight of the coating composition, 1% or more; more preferably 2% or more. Preferably, the amount of the encapsulated active is, based on the weight of the coating composition, is 7% or less; more preferably 5% or less.

Optionally, the coating composition may contain a co-biocide. If a co-biocide other than the dried encapsulated active and the metal-containing dried composition of the encapsulated active is present, the co-biocide is preferably chosen from the group consisting of zinc pyrithione, copper pyrithione, tolyl fluinid, dichlo fluinid, diiodomethyl-p-tolylsulfone (DIMTS), 2-methylthio-4-tert-butylamino-6-isopropylamino-s-triazine, dichlorophenyl dimethyl urea, zinc,bis(N,N-dimethylcarbamodithioato-kS,kS′)[m-[[N,N′-1,2-ethanediylbis [carbamodithioato-kS,kS′]](2-)]]di- (TOC 3204F), zinc ethane-1,2-diylbis(dithiocarbamate) (Zineb), non-encapsulated DCOIT, cuprous oxide, cuprous thiocyanate, spinosad, spinetoram, medetomidine, cypermethrin, tralopyr, TPBP, and mixtures thereof.

The coating composition of the present invention is preferably used as an anti-fouling coating; more preferably as a marine anti-fouling coating composition.

A coating method includes applying a layer of the coating composition of the present invention to a substrate. The maximum thickness of the layer is preferably chosen so that the dry film thickness will be 50 micrometers or more; more preferably 100 micrometers or more. The minimum thickness of the layer is preferably chosen so that the dry film thickness will be 1 millimeter or less; more preferably 500 micrometers or less; more preferably 300 micrometers or less.

The composition of the present invention containing the encapsulated active and the metal additive has increased release of the active from the core of the encapsulated active. The release is the amount of active that diffuses into a medium over a set period of time. A medium may include solvent, water, seawater, artificial seawater, or air. A preferred medium is seawater. A preferred medium is artificial seawater. A preferred set period of time is 3 days or more; more preferably 7 days or more; more preferably 14 days or more.

A comparison of the release of the active of the present invention may be made with the release of the active from a control. A control is a composition containing an encapsulated active which does not contain a metal additive, for example a coating composition containing the dried encapsulated active. An increased release includes a release of the active from the composition of the present invention that is at least 8% or more than the release of the active from the control; more preferably 10% or more than the release of the active from the control.

The amount of active released into the medium may be measured using standard analytical techniques including column chromatography (for example, LC, GC, HPLC), mass spectroscopy, NMR, light spectroscopy (for example, UV, FTIR, Raman), thermal analyses (for example, DSC, TGA) or combinations thereof. A preferred method to measure the amount of active released is liquid chromatography.

A coated substrate is a substrate prepared using the coating method. The coated substrate containing the coating composition may be immersed into a medium and the release of the active from the coated substrate into the medium measured. A preferred method to calculate the amount of active released from the coated substrate is measurement of the amount of active absorbed onto polymer-coated stir bars. A preferred polymer for the polymer-coated stir bars is polydimethylsiloxane. The polymer-coated stir bar is included in the medium containing the coated substrate.

The active on the polymer-coated stir bar may be removed from the stir bar by dissolving the active from the stir bar into another medium. The medium to dissolve the active from the polymer-coated stir bar may be, for example, any solvent in which the active is soluble. The active dissolved from the polymer-coated stir bar into the medium may be measured using standard analytical techniques. The active dissolved from the polymer-coated stir bar may be measured at a set period of time. After the polymer-coated stir bar is removed from the medium containing the coated substrate to make a measurement, it may be replaced back into the medium for subsequent measurements.

The release of the active from the coated substrate may be calculated by dividing the cumulative amount of active dissolved from the polymer-coated stir bar by aa) and bb) where aa) is the set period of time and bb) is the surface area of the coated substrate.

In another aspect of the present invention, the release of the active may be measured from a release mixture containing the metal-containing dried composition and a medium. The preferred medium in the release mixture is one of the following: seawater and artificial seawater. The preferred amount of metal-containing dried composition in the release mixture, based on the total weight of the release mixture, is 0.01% or more. The preferred amount of metal-containing dried composition in the release mixture, based on the total weight of the release mixture, is 5% or less; more preferably 2.5% or less.

The active released from the release mixture may be calculated as the amount of active released as a percentage of the active loaded and is defined as AR. AR may be measured at a set period of time. The release rate is the difference between AR for two set time periods divided by the time period. For example, the difference between AR for day 21 and AR for day 7 would be divided by 14.

The following are examples of the present invention wherein all parts and percentages are by weight unless otherwise specified.

In the examples the following test procedures are used.

Method A Coating Compositions

Micron™ 66 paint, available from Akzo, was shaken using a Red Devil™ paint mixer for 1 to 2 minutes. 40 grams of paint was put into a 100 ml plastic bottle. 3% of the dried encapsulated active or 3% of the metal-containing dried composition of the encapsulated active, based on the weight of the paint, was added to the paint and agitated using the Red Devil™ paint mixer for 15 minutes. A 500 micron wet layer of the paint mixture was applied onto a Leneta paper substrate using a stainless steel gauge and allowed to dry for 14 to 24 hours.

Method B Coating Compositions

Micron™ 66 paint, available from Akzo, was shaken using a Red Devil™ paint mixer for 1 to 2 minutes. 40 grams of paint was put into a 100 ml plastic bottle. 3% of the dried encapsulated active, based on the weight of the paint, and 3% of the metal additive, based on the weight of the paint, was added to the paint and agitated using the Red Devil paint mixer for 15 minutes. A 500 micron wet layer of the paint mixture was applied onto a Leneta paper substrate using a stainless steel gauge and allowed to dry for 14 to 24 hours.

The release of the active from the coating composition was measured using the sorptive stirring bar technique. The coated substrates prepared using Method A or Method B were immersed into 120 ml glass bottles containing 100 ml of artificial seawater (available from Ricca Chemical Company ASTM D1141) and a GERSTEL Twister™ stirring bar (a polydimethylsiloxane coated stir bar available from Gerstel Gmbh) and stirred at 600 rpm. At designated times, the GERSTEL Twister bars were removed from the bottle, wiped with paper towel and the absorbed active was extracted from the GERSTEL Twister bars at 35° C. for 30 minutes in 1 ml acetonitrile. The amount of active extracted was measured using HPLC. The release of the encapsulated active, R (microgram/square centimeter), from the coated substrate was calculated using the equation R=C/A where C is the quantity of released active (microgram) and A is the surface area of immersed paint substrate (square centimeter).

### EXAMPLE 1

### Encapsulated Active with Inner Encapsulant E1 and with Metal Additive Added to the Aqueous Composition of the Encapsulated Active

The synthesis procedure in Example 2 in U.S. Pat. No. 7,550,200 was used to prepare the encapsulated active in the present Example 1 with minor modifications. Below is a brief description of the synthesis procedure used. Minor differences between the synthesis procedures in U.S. Pat. No. 7,550,200 and in the present invention are specified. An asterisk (*) will be used to identify the control samples.

Two batches of encapsulated active were prepared using the following method. These two batches are labeled Batch1 and Batch2. An aqueous mixture was prepared containing 1.10 g of ethylene maleic anhydride (EMA) co-polymer (available from Vertellus) and 32.65 g of water. With stirring, 0.81 g of a 45% KOH aqueous solution was added to the EMA mixture and held at 85° C. for 20 min Kathon™ 287T preservative (176.39 g, 99% manufactured by The Dow Chemical Company) was melted in a 50° C. oven. An emulsion was prepared by mixing the melted Kathon 287T preservative with the aqueous EMA mixture at 48° C. in a 1 L kettle. The pH of the emulsion was adjusted to 4.7 and the emulsion stirred for up to 30 min to produce Kathon 287T preservative emulsion droplets mostly in the range 10-50 microns. While maintaining the temperature at 48° C., a mixture of 8.14 g Cymel 385 cross-linking agent (90%, manufactured by Cytec) and 6.2 g water was added to the emulsion. The emulsion was mixed with an IKA™ magic LAB™ dispersing machine at 6400 rpm for 10 minutes to produce Kathon 287T preservative emulsion droplets with greater than 90% of the droplets having a mean volume diameter in the range 10 to 30 micron. A salt solution was prepared by slowly mixing 2.06 g of a 75% H₃PO₄ aqueous solution to 10.94 g water followed 1.92 g of a 45% KOH aqueous solution. The salt solution was added to the emulsion mixture and heated at 65° C. for 1 hr. A polyvinyl alcohol (PVA) mixture containing 5.43 g Celvol® 540 polyvinyl alcohol (available from Celanese) and 5.43 g Celvol™ 125 polyvinyl alcohol (available from Celanese) and 206.24 g of water was added to the emulsion mixture and the temperature reduced to 45° C. A first urea/resorcinol mixture was prepared by adding 4.07 g urea to 40.70 g water followed by 2.71 g resorcinol. The first urea/resorcinol mixture was stirred to dissolve and added to the emulsion mixture over a 10 to 15 minute period. A solution of 22.20 g of 37% formalin (37% formaldehyde aqueous solution) was added over a 10 to 15 minute period followed 10 minutes later by the addition of 15.06 g of a 10% sulfuric acid aqueous solution over a 10 to 15 minute period. The resulting slurry was warmed to 45° C. and after about an hour a solution of 2.04 g of urea, 1.36 g resorcinol, 20.4 g water and 9.25 g of 37% formalin was added over a 15 minute period. A solution of 2.04 g of urea, 1.36 g resorcinol, 20.4 g water and 9.25 g of 37% formalin was added over another 15 minute period. The slurry was heated to 55° C. and allowed to stir for 16 hours. The slurry was cooled to ambient temperature and pH adjusted to 7.0 using 10% sodium hydroxide aqueous solution. The slurry was filtered using a 125-150 micron sieve and rinsed with water. The filtered encapsulated active material was re-slurried with water and vacuum-filtered using Whatman 4.0 paper.

A metal additive was added to the aqueous composition of the encapsulated active prepared in Example 1 using the Method A coating composition. Table 1 includes the amount of metal additive used and was based on the weight of the dried encapsulated active. Batch1 from Example 1 included samples 1-A1 and 1-A1*. For example, to a 20% aqueous solution of the vacuum-filtered encapsulated active was added 0.75% CuSO₄, based on encapsulated active solids, and spray dried and was referred to as sample 1-A1. A second 20% aqueous solution of the vacuum-filtered encapsulated active was spray dried without the addition of CuSO₄ and was referred to as sample 1-A1*. The encapsulated actives were tested for release by preparing the Method A coating composition and using the sorptive stirring bar technique. Table 1 shows sample 1-A had a 39.3% increase in the release compared to 1-A1*.

Batch2 from Example 1 included samples 1-B2, 1-C2, 1-D2, 1-E2, 1-F2, 1-G2, and 1-H2*. The encapsulated actives were tested for release by preparing the Method A coating composition and using the sorptive stirring bar technique. The % increase in release for the metal-containing coating compositions ranged from 14.3 to 75.6% compared to a coating composition to which no metal salt was added (1-H2*).

### EXAMPLE 2

### Encapsulated Active with Inner Encapsulant E1 and with Metal Additive Added to the Coating Composition

Encapsulated active was prepared using the procedures of Example 1. The dried encapsulated active was tested for release by preparing the Method B coating composition and using the sorptive stirring bar technique. Table 2 includes the amount of metal additive that was used in the Method B coating composition and was based on the weight of the dried encapsulated active. The % increase in release for the metal-containing coating compositions was 151% compared to a coating composition to which no metal salt was added.

### EXAMPLE 3

### Encapsulated Active with Inner Encapsulant, E2 and with Metal Additive Added to Coating Composition

The synthesis procedure in Example 1 in U.S. Pat. No. 6,486,099 was used to prepare the encapsulated active in the present Example 3. Below is a brief description of the synthesis procedure used. Differences between the synthesis procedures in U.S. Pat. No. 6,486,099 and in the present invention are specified.

Two batches of encapsulated active were prepared using the following method. These two batches are labeled BatchI and BatchII. An aqueous solution was stirred at 50° C. containing 660.03 g water, 41.15 g U-Ramin™ P-1500 resin (40% aqueous solution, available from Mitsui Kagaku K.K.), and 7.95 g triethanolamine (20% aqueous solution) in a 3 L reaction vessel. The pH of the mixture was adjusted to 4.75 by adding 5% citric acid. Kathon 287T preservative (352.44 g, 97%, manufactured by The Dow Chemical Company) was melted in a 60° C. water bath. The melted Kathon™ 287T preservative and 47.35 g of 1% aqueous sodium dodecylbenzenesulfonate (“NEOPELEX™” surfactant available from Kao K.K.) were added to the reaction vessel sequentially. The mixture was pumped through an IKA™ magic LAB™ dispersing machine at 7600 rpm and 360 ml/min for 10 minutes. With stirring, the UF and MF amino resin prepolymers were added to the reaction vessel over a 10 minute time period using an addition funnel. The UF prepolymer was prepared by mixing 17.82 g urea and 33.46 g formalin (37% formaldehyde aqueous solution adjusted to pH 8.0 by addition of 20% triethanolamine aqueous solution) and 17.82 g water. The UF prepolymer solution was heated to 70° C. and held there for 45 minutes. The MF prepolymer was prepared by mixing 17.39 g melamine and 34.62 g formalin (37% formaldehyde aqueous solution adjusted to pH 8.0 by addition of 20% triethanolamine aqueous solution) and 62.09 g water. The MF prepolymer solution was heated to 50° C. and held there for 60 minutes. After the addition of the UF and MF amino resin prepolymers to the reaction vessel, the pH was adjusted to 4.75 with 10% citric acid aqueous solution and stirred at 50° C. After 2.5 hours, the pH was adjusted to 2.8 with 30% citric acid aqueous solution and stirred at 50° C. from 14 to 24 hours. The mixture was cooled to ambient temperature and 24.16 g ammonium chloride added. After 10 minutes, the pH was adjusted to 7.0 using 25% sodium hydroxide solution and stirred for 10 minutes. The pH was adjusted to 7.0 using 25% sodium hydroxide solution and stirred for 100 minutes. The slurry was filtered using a 100 micron sieve and rinsed with water. The filtered encapsulated active material was re-slurried with water and vacuum-filtered using Whatman 4.0 paper. A 20% aqueous solution of the vacuum-filtered encapsulated active was spray dried.

The dried composition of the encapsulated active was tested for release by preparing the Method B coating composition and using the sorptive stirring bar technique. Table 3 includes the amount of metal additive that was used in the Method B coating composition and was based on the weight of the dried encapsulated active. BatchI from Example 3 included samples 3-A1 and 3-A1*. BatchII from Example 3 included samples 3-B2 and 3-B2*. The % increase in release for the metal-containing coating compositions ranged from 30 to 56% compared to a coating composition to which no metal salt was added.

TABLE 1

| Sample | 1-A1 | 1-A1* | 1-B2 | 1-C2 | 1-D2 | 1-E2 | 1-F2 | 1-G2 | 1-H2* |
|---|---|---|---|---|---|---|---|---|---|
| Metal | CuSO₄ | none | MgSO₄ | NaSO₄ | NiSO₄ | ZnSO₄ | CuCl₂ | CaCl₂ | none |
| Additive | 0.75% | | 0.5% | 0.5% | 0.5% | 0.5% | 0.5% | 1% | |
| Day 28 | 1.36 | 0.97 | 1.91 | 1.88 | 1.98 | 2.04 | 2.93 | 2.80 | 1.67 |
| Release¹ | | | | | | | | | |
| % Increase | 39.3 | | 14.3 | 12.6 | 18.8 | 22.1 | 75.6 | 67.8 | |

¹micrograms/square centimeter

TABLE 2

Sample

| | 2-A1 | 2-B1* |
|---|---|---|
| Metal Additive | CuSO₄ 1% | none |
| Day 28 Release¹ | 2.44 | 0.97 |
| % Increase | 151 | |

¹micrograms/square centimeter

TABLE 3

| | Sample | | | |
|---|---|---|---|---|
| | 3-A1 | 3-A1* | 3-B2 | 3-B2* |
| Metal Additive | CuSO₄ 1% | none | copper pyrithione 3% | none |
| Day 28 Release¹ | 5.93 | 4.54 | 1.30² | 0.84² |
| % Increase | 30.6 | | 56 | |

¹micrograms/square centimeter
²Day 21 release

1. A composition with increased release comprising
A) an encapsulated active and
B) one or more metal additive.

2. A coating composition comprising
A) an encapsulated active and
B) one or more metal additive and
C) one or more binder polymer, one or more binder precursor, or a mixture thereof; and
D) one or more pigment.

3. The composition of claim 2 wherein the coating composition is a marine anti-fouling coating composition.

4. A method of making the composition of claim 1 comprising addition of said B) into at least one of i), ii), or iii) wherein
i. is an aqueous dispersion of the encapsulated active and
ii. is a solvent dispersion of the encapsulated active and
iii. is the dried composition of the encapsulated active.

5. The composition of claim 1 wherein said composition further comprises
C) one or more binder polymer, one or more binder precursor, or a mixture thereof; and
D) one or more pigment.

6. The composition of claim 2 wherein said encapsulated active comprises an amine resin.

7. The composition of claim 2 wherein said encapsulated active comprises an agricultural chemical or biocide or mixture thereof.

8. The composition of claim 2 wherein said metal additive comprises one or more of
a) a transition metal,
b) metal cation selected from periodic group 1, and
c) metal cation selected from periodic group 2.

9. A method of making the composition of claim 2 comprising at least one of the steps of:
I. forming a dried composition comprising said metal additive and said encapsulated active, and then mixing said dried composition with said C) and said D) or
II. forming a dried composition comprising said encapsulated active, then mixing said dried composition with said metal additive, said C) and said D) or
III. forming a solvent dispersion comprising said encapsulated active and said metal additive, then mixing said solvent dispersion with said C) and D).

10. A method of providing a surface that resists marine fouling wherein said method comprises applying a layer of the composition of claim 2 to a substrate and drying said layer or allowing said layer to dry.
